(19) United States
(12) Patent Application Publication
(10) Pub. No.: US 2015/0289652 A1
(43) Pub. Date: Oct. 15, 2015

(54) Movable Ergonomic Carrier for Desktop Computer

(71) Applicant: Slavisa STRAHINIC, (US)

(72) Inventor: Slavisa Strahinic, Prokuplje (RS)

(21) Appl. No.: 14/443,612

(22) PCT Filed: Nov. 12, 2013
(86) PCT No.: PCT/RS2013/000021

§ 371 Date: May 18, 2015

(30) Foreign Application Priority Data
Nov. 16, 2012 (RS) MP-2012/0070

(51) Int. Cl. A47B 97/00; F16M 11/20; F16M 11/42

(52) U.S. Cl. CPC A47B 97/00; F16M 11/42; F16M 11/2042; A47B 2097/006

(57) ABSTRACT

with the following novelties: rectangular pedestal (83) which consists of the boxes (1 and 2) whose outer flanks have places (16 and 17) for mounting the weight (18), and L-profiles (3 and 4) and the boxes (1 and 2) have the boxes (5 and 6) pulled into them whose ends have the castor (7 and 8) carriers welded to them bearing the castors (9 and 10) which provide adjustment of the distance between the castors (9 and 10) and ends of the boxes (1 and 2), and upper side of the pedestal (83) have welded sleeves (19, 20, 21, 22) in their corners where there are pulled in and fixed the pipes (23, 24, 25, 26) whose tips go into the sleeves (34, 35, 36, 37) of the rectangular frame (33) where they are fixed with the fixation (38, 39, 40, 41) elements going through each of their sides so that the elements (38 and 39) also fix the bars (42 and 43) whose tips include the joints (44 and 45) which are pulled into the pipes (23 and 24), so that the joint (44) is in turn followed by the bar (46), pipe (47), joint (48), pipe (50), bar (51) and the mount (52) arm, while the joint (45) is in turn followed by the pipe (53), joint (54), pipe (55), joint (57) and the pipe (60) with the carriers (68 and 69) of the keyboard with the mouse (80) pedestal.

### TECHNICAL FIELD

The invention falls into the technical area which relates to the desks specially designed for use in individual computer work stations.

According to the International Patent Classification (IPC), the symbols are:

| | |
|---|---|
| A47B 21/013 | Characterized by adjustable parts, e.g. universally |
| | adjustable leaves, arm rests, wrist supports or |
| | mouse platforms. |
| A47B 21/02 | the parts being vertically adjustable only. |
| A47B 21/03 | the parts being horizontally adjustable, e.g. |
| | extensible, only. |
| A47B 21/04 | characterized by means for holding or fastening |
| | typewriters or computer equipment. |

### Technical Issue

How to solve the technical issue concerning movability of a desktop computer by joining its basic components (the tower, monitor, keyboard and mouse) with the construction enabling use of the computer in sitting, standing and lying position.

### BACKGROUND ART

Movable ergonomic carrier for desktop computers enables the user to choose between using the computer while sitting, standing or lying down, as well as simply relocating the computer in the room or from one room to another.

Known solutions dealing with this technical issue are those by company Ergoquest from the United States of America.

Near the top of the 185 cm high column, which is fastened to the pedestal with 4 castors in the shape of the Cyrillic letter P (Π), and particularly in the middle of the bracket joining together two parallel brackets, there is the joint which is followed by double joints, so called the mount arm, which can be rotated around a horizontal and vertical line. Near the top of the mount arm there is the monitor fastening and the extension ending with the surface fastened to it for holding the keyboard and mouse. Thus, monitor, keyboard and mouse are carried by the same joint. The shortcoming of this solution is that the position of the monitor, in terms of height and distance from the user, also determines the position of the keyboard and mouse and vice versa.

There is another variant of the solution where the keyboard and mouse are on the special mount arm located in the middle or the top of the main column bearing the mount arm of the monitor. Common shortcomings of both first and second option are as follows:
1. Dependence to use the special, ergonomic chair. Since the use of keyboard and mouse requires the surface underneath to be stable, so as to prevent its vertical movement during use, and in these cases the surface is fastened to the mount arm which is both vertically and horizontally rotatable, the stability of the surface needs to be provided somehow. The author solved this problem by also envisaging as the mandatory accessory of the carrier, the ergonomic chair with arm rests on which the surface for the keyboard and mouse rests. The ergonomic chair is electrically powered and can be placed in seating and lying position. It is positioned between parallel brackets making the pedestal, so that its flank is parallel to the transverse bracket joining the parallel brackets.
2. The keyboard and mouse cannot be used in standing position due to a lack of stable surface.
3. The computer tower stands on the transverse bracket of the pedestal so that the user of the computer in the ergonomic chair is not adequately distant, especially in lying position, from negative electromagnetic radiation emanating from certain components placed in the tower.
4. The dimensions of the carrier itself. The parallel brackets of the pedestal have sufficient length to provide stability to the entire carrier because the column itself is quite high. However, that makes use of the carrier without the ergonomic chair, on a common bed, difficult as it makes too much distance between the carrier column and the bed. Furthermore, it also makes using the carrier difficult at ordinary table or desk. The desk would have to be placed between the parallel brackets of the pedestal so that one of the brackets would interfere with placing and using chair.
   Although positioned on castors, the carrier is not easily moved in the room or from one room to another due to its size, especially if a desktop computer is placed on it. Furthermore, when the computer is out of use and when it needs to be put out of the way, the carrier still takes up a lot of space.
   Certain elements of the carrier have such size that even when the carrier is disassembled in order to be packed and transported, it still takes up a lot of space.
5. The price of one of the carriers together with the ergonomic chair is 10 to 15 times greater than the production price of the invention.

### DISCLOSURE OF INVENTION

The invention represents metal construction enabling the user to choose between using the computer while sitting, standing or lying down and particularly in sitting and lying position using any type of chair or bed, without making it necessary to use special ergonomic chairs or beds which pose a condition for efficient use of the carriers described in the Technical State. Furthermore, it enables the user to relocate the computer inside the room or from one room to another in a quick and simple way.

The advantage of the invention is in its construction because joints with pipe carriers of the keyboard and mouse can only be rotated around a horizontal but not vertical line, thus providing stability necessary for their efficient use in whatever position the user may be. Furthermore, there can also be adjusted the height of the bars carrying joints which include the pipe carriers of the monitor, keyboard and mouse so they are not always extended maximally, but only when it is necessary. Furthermore, they can also be drawn out, i.e. made further from the flank of the pedestal to the specific length of the two flank castors being on the same side. They will be drawn out only as far as it is necessary to provide stability to the entire carrier but not always all the way out. Because of the places of the pipe carriers of the monitor, keyboard and mouse, which are always in the front of the pedestal, to the right or left of the tower front, the invention may be placed so that the user, whether he be sitting, standing or lying down, is at safe distance from harmful electromagnetic radiation emitted by certain components inside the computer tower.

Because of the smaller size of its constituent elements, the invention can be easily disassembled and packed for transport. It is lighter, takes up less space, and its rectangular pedestal and rectangular frame make it easy to move inside the room or from one room to another.

### BRIEF DESCRIPTION OF DRAWINGS

FIG. 1 shows mobile ergonomic carrier of desktop computer set for the seating position, upper left axonometric projection

FIG. 2 shows mobile ergonomic carrier of desktop computer set for the standing position, upper left axonometric projection

FIG. 3 shows mobile ergonomic carrier of desktop computer set for the lying position, upper right axonometric projection

### BEST MODE FOR CARRYING OUT OF THE INVENTION

The invention is a construction made of the following types of metal elements:

Pipes, bars, L-profiles, boxes, guides and fastening elements (bolts). In addition to them, there are also 4 castors, plywood as the pedestal for the mouse and the weight of flat bar rectangular frame filled with concrete.

The pedestal 83 of the invention is rectangular, its shorter sides being 30 cm long each and longer sides being 48 long each. The shorter sides are made of boxes 1 and 2 each being 30 cm long, 4 cm high and 4.5 cm wide. Their inside dimensions are: 30 cm long, 3.2 cm high and 4.2 cm wide each. The longer sides 3 and 4 are made of L-profile each being 39 cm long, 4 cm high and 4 cm wide. The sides are welded. The tops of each of the boxes 1 and 2 are open just on one side and particularly those that emerge on the same flank of the pedestal 83, and so they have the boxes 5 and 6 drawn into them, each being 29 cm long, 3 cm high and 4 cm wide, whose upper top surfaces, each being 2 cm long and 4 cm wide, have welded flat bars each being 7.5 cm long and 4 cm wide, representing the carriers 7 and 8 of the castors, so that when the boxes 5 and 6 are fully drawn in the boxes 1 and 2, the carriers 7 and 8 of the castors are aligned with the upper surface of the pedestal 83. The castors 9 and 10 which are revolving, are fastened for the carriers 7 and 8 of the castors with the elements 85 and 87 for fastening. The box 6 is fastened in the appropriate position with the element 11 for fastening. The box 5 is fastened in the same way. On the opposite flank of the pedestal 83, the carriers 12 and 13 of the castors each 7.5 cm long and 4 cm wide are welded to the ends of the pedestal 83 perpendicularly with their shorter sides and so they are aligned with the upper edge of the pedestal 83. The castors 14 and 15 which are revolving are fastened to the carriers 12 and 13 of the castors with the elements 84 and 86 for fastening. The upper surface of the pedestal 83 has two flat bars 27 and 28 welded, each being 22 cm long and 4 cm wide. The flat bar 27 is welded to the side of the box 1 and in front and back part to the L-profiles 3 and 4. The other flat bar 28 is laterally welded to the box 2, while its front and back are welded to the L-profiles 3 and 4.

At the front part of the pedestal 83, places 16 and 17 are welded to mount the weight, each being 3 cm long, 2 cm wide and 4 mm high, and those same places are also in the back of the pedestal 83. The weight 18, dimensions: 30 cm×16 cm×4 cm, weighing 5 kg is aligned with the pedestal 83 when mounted to it. Its purpose is to provide further stability to the movable ergonomic carrier of the desktop computer and serve as the pedestal to which the sockets of extension cable are fastened, providing the computer with power.

The upper surface of the pedestal 83 has one 4 cm long sleeve 19, 20, 21, 22 in all four corners. They have pipes 23, 24, 25, 26, each being 48 cm long, pulled into them and fastened with the elements 29, 30, 31, 32 for fastening. The pipe tops 23, 24, 25, 26 have, in the length of their sleeve, pulled onto them rectangular frame 33 consisting of pipes, two of which are 38 cm long and the other two 25 cm long, whose ends are welded to four sleeves 34, 35, 36, 37, each being 3 cm long. The frame is fastened to the pipes through the elements 38, 39, 40, 41 for fastening, but these elements go through the pipes and only on one side.

The pipes 23 and 24 have the bars 42 and 43 pulled into them, each being 2.2 cm in diameter. They are the same length as the pipes, but have the lower parts of the joints 44 and 45 welded to their tops, as the extensions. The bars 23 and 24 can be vertically pulled in and out to the length of the pipes in which they are placed and fastened in appropriate position with the elements 38 and 39 for fastening. The upper part of the joint 44 has the bar 46, being 2.2 cm in diameter and 30 cm long, welded to it at the angle of 45° up to the place where it is angled and is further perpendicular to the bar 42. In the length of 20 cm, the bar 46 is pulled into the pipe 47 being 27 long, the end of which has the lower part of the joint 48 welded to it perpendicularly. The pipe 47 is fastened to the bar 46 with the element 49 for fastening. The upper part of the joint 48 has one end of the pipe 50 perpendicularly welded to it. The length of the pipe 50 is 33 cm. The pipe 50 has on the other end pulled into it to the length of 10 cm, one arm of the bar 51 bent perpendicularly, while the other arm to the length of 11 cm goes into the so called the mount 52 arm. The bar 51 is fastened to the mount 52 arm with the element 53 for fastening. The mount 52 arm is designed to have the computer monitor fastened to it which allows monitor rotation around a horizontal and vertical line as well as circular motion. Furthermore, it also provides height adjustment of the monitor in the range of 0° to 90°.

The upper half of the joint 45 has one end of the pipe 53 welded to it perpendicularly. The pipe 53 is 36 cm long. The other end of the pipe 53 is welded, also perpendicularly, to the lower part of the joint 54. The upper part of the joint 54 has one end of the pipe 55 welded to it. The pipe 55 is 33 cm long. The other end of the pipe 55 has pulled into it the bar 56, 2.2 cm in diameter and 5 cm long. The top of the bar 56 has the lower part of the joint 57 perpendicularly welded to it. The bar 56 is fastened to the pipe 55 with the element 58 for fastening. The upper half of the joint 57 has sleeve 59, 4 cm long, welded to it. The sleeve 59 is perpendicularly welded to the top of the upper half of the joint 57 in the middle of its body. The sleeve 59 has pipe 60 pulled through it, which is fastened to it with the element 61 for fastening. The pipe 60 is pulled through two more sleeves 62 and 63, each being 3 cm long, which have welded to them the guides 64 and 65 of the keyboard carrier, each being 8 cm long and 3 cm wide. The sleeves 62 and 63 with the guides 64 and 65 of the keyboard carrier are fastened to the pipe 60 with the elements 66 and 67 for fastening. The guides 64 and 65 of the keyboard carrier have pulled into them the keyboard 68 and 69 carriers, each being 18 cm long, plus the curved lower ends being 1 cm long and 2.5 cm wide. The keyboard 68 and 69 carriers are fastened to the guides 64 and 65 of the keyboard carrier with the elements 70 and 71 for fastening. The upper ends of the keyboard 68 and 69 carriers have pulled onto them the elements 72 and 73 for the keyboard fastening, each being 2 cm long and 3 cm wide, and their parts 3 cm long and 2 cm wide which are perpendicular and whose purpose is to rest on the keyboard. The elements 72 and 73 for the keyboard fastening are fastened to the carriers 68 and 69 of the keyboard with the elements 74 and 75 for fastening. The other end of the pipe 60 has the bar 76 pulled into it. The bar 76 is 20 cm long and 1.6 cm in diameter. The bar has perpendicularly welded to it the top of the pipe 77, 11.5 cm in length with the outer diameter being 1.6 cm and inner being 1.3 cm. The bar 76 is fastened to the pipe 60 it goes into with the element 78 for fastening. The bar 79 bearing the pedestal for the mouse, being 11.5 cm long and 1.2 cm in diameter is pulled into the pipe 77. The bar 79 is fastened to the pipe 77 with the element for fastening 81.

Everything, except for the pipe 60, which ½″ and the pipe 77, is ¾″. The joints 44, 45, 48, 54, 57 enable rotation of the elements fastened to them, but only around a horizontal line.

The computer tower is placed on the pedestal 83 which consists of the boxes 1 and 2 and L-profiles 3 and 4 and between the pipes 23, 24, 25, 26 so that its rear part could be turned to the weight 18. The boxes 5 and 6 to which are welded the carriers 7 and 8 bearing the castors 9 and 10, need to be sufficiently pulled out from the boxes 1 and 2 so that the castors 9 and 10 should each be 15 cm away from the boxes 1 and 2, thereby providing the full stability of the movable ergonomic carrier of the monitor weighing up to 5 kg and particularly when the monitor, keyboard and mouse are at the maximum distance from the computer tower. The monitor can be placed on the mount 52 arm and fastened with bolts. The keyboard is placed to the keyboard 68 and 69 carriers so that its lower edge fits the curved parts of the keyboard 68 and 69 carriers. That can be achieved regardless of the shape of the lower keyboard edge since the keyboard 68 and 69 carriers can be independently pulled out of the guides 64 and 65 of the keyboard carrier up to a certain length and fastened in the suitable position. To the upper ends of the keyboard 68 and 69 carrier, the elements 72 and 73 for the keyboard fastening lean to the upper edge of the keyboard and are fastened with the elements 74 and 75 for fastening. That secures the keyboard stability. The mouse is placed in its pedestal 80 the edges of which in the front part are mildly lifted in order to keep the mouse from falling from the pedestal 80 when it is out of use.

The user adjusts the distance of the monitor from himself by grabbing the flanks of the monitor and rotating the bar 46 and the pipes 47 and 50 which include the joints 44 and 48, and moving the monitor sideways where the castors 9 and 10 are located and thus adjust the distance by pulling closer or pushing away. When the user positions the monitor at the suitable distance, he can position the monitor vertically as it suits him That can be done in two ways. The first, by rotating the mount 52 arm vertically. The second, by pulling out the bar 42 to the suitable height and fixing it with the element 38 for fastening.

The user can adjust the distance of the keyboard and mouse from him by rotating the pipe 53 and 55 and the pipe 60 which feature the joints 45, 54, 57 by grabbing with the left hand the ball 82, which is bolted to the top of the pipe 60, and the pedestal of the mouse 80 with the right, pull the side where the castors 9 and 10 are located and thus regulate the distance by pulling it towards or away from himself. The keyboard height adjustment is carried out by pulling out the bar 43 to the suitable height and fix it with the element 39 for fastening. The angle adjustment of the keyboard to the user can be carried out horizontally and vertically. Horizontal adjustment can be done in two ways. The first way is to adjust the angle of the keyboard by rotating the pipe 60 in the sleeve 59, and when it assumes the suitable angle, the pipe 60 is then fastened to the sleeve 59 with the element 61 for fastening. The second way is to adjust the keyboard angle by rotating the sleeves 62 and 63 around the pipe 60, and when it assumes the suitable angle, the sleeves 62 and 63 are then fastened to the pipe 60 with the elements 66 and 67 for fastening. The keyboard angle can be vertically adjusted by rotating the bar 56 in the pipe 55, and when it assumes the suitable angle the bar 56 is then fastened to the pipe 55 with the element 58 for fastening.

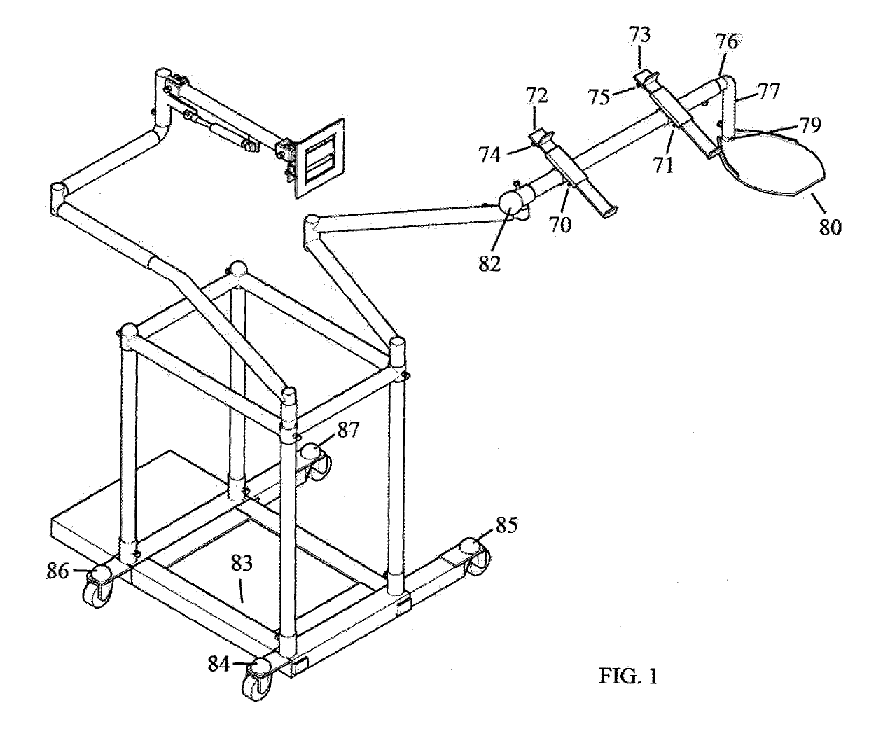

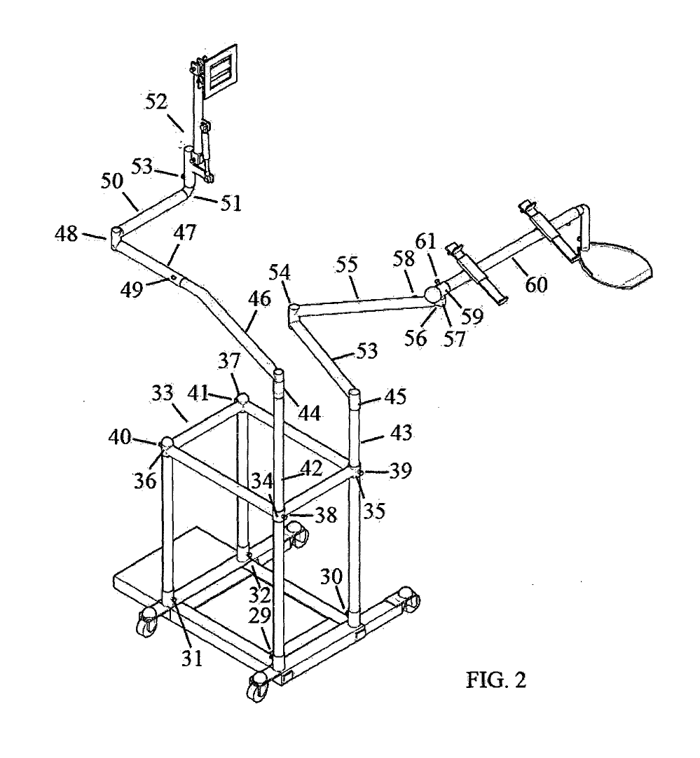

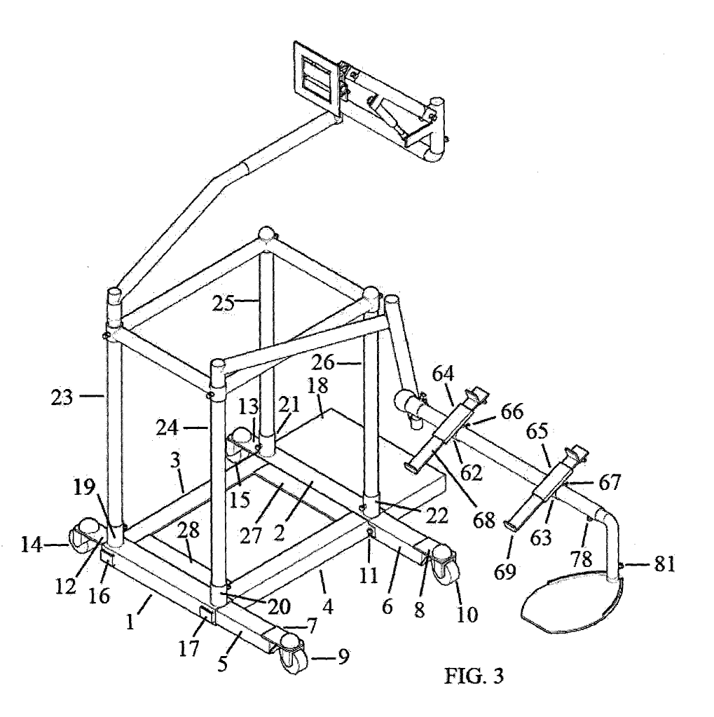

Angle adjustment of the mouse 80 pedestal may be carried out by rotating the bar 76 in the pipe 60 so that when the mouse 80 pedestal assumes the suitable angle, the bar 76 is fastened to the pipe 60 with the element 78 for fastening. The pedestal 80 of the mouse can be moved to the right to the length of up to 17 cm by pulling out the bar 76. The height adjustment of the mouse 80 pedestal can be done by pulling out the bar 79 to which the mouse 80 pedestal is welded, which goes into the pipe 77. If the user wants to use the computer in the sitting position, he needs to set the ergonomic carrier as shown in the FIG. 1, but the chair needs to be placed in front of the front tower and not sideways to the castors 9 and 10. If the user wishes to use the computer in the standing position he needs to adjust the ergonomic carrier as shown in the FIG. 2, and he can stand in different positions in relation to the computer tower. If the user wants to use the computer in the lying position, he needs to adjust the ergonomic carrier as shown in the FIG. 3. The carrier needs to be placed to the side of the bed so that the flank of the computer tower is parallel to the bed at the distance of 50 cm. The bar 46 can rotate together with the pipes 47 and 50 and the mount 52 arm through the joints 44 and 48 so as to enable the monitor placed on the mount 52 arm to be over the bed. The FIG. 3 shows the mobile ergonomic carrier adjusted to enable the user to use the computer while lying, with the tower being to his left. If the user wishes to use the computer with the tower being to his right, he needs to transfer the bar 42 from the pipe 23 into the pipe 25 together with the bar 46 and the pipes 47 and 50 and the mount 52 arm to which it is connected with the joint 44. The mount 52 arm must be rotated horizontally for 180° around the part of the bar 51 which goes into it and fix it with the element 53 for fastening. Then the user must transfer the bar 43 from the pipe 24 into the pipe 26 together with the pipes 53, 55 and 60 with which it is connected with the joint 45. The Sleeve 59 is to be fastened to the pipe 60 closer to the end with the mouse 80 pedestal. The weight 18 is then to be transferred to the opposite side and fastened in the places 16 and 17.

### INDUSTRIAL APPLICABILITY

The invention can be used by anyone who owns a desktop computer, whether for business, studying, internet surfing or gaming. When adjusted for the standing position, the invention may find application in places where the computer is suitable to be used in that position, such as presentations, lectures studies and medical practices etc.

It can also be used in offices by placing it to the left or right side of the desk and rotating the monitor, keyboard and mouse so as to position them over the desk. Furthermore, it can also be used by persons forced to spend time in the lying position due to handicap or injury, as well as garners because of the length of time they spend by the computer.

1. The movable ergonomic carrier for desktop computer consists of the metal pedestal 83, shaped like the Cyrillic letter p (Π) encompassing boxes 1, 2 and 3 the ends of which as well as the corners of the elements 84, 85, 86, 87 for have the castors 9, 10, 14, 15 fastened to them, and the middle of the transverse box 3 joining two parallel boxes 1 and 2 welded perpendicularly has the pipe 23 in the middle of which there is the joint 45 to which is fastened the mount 52 arm bearing the pedestal 80 for the keyboard and mouse, the top of the pipe 23 includes the joint 44 with the bar 46 following it perpendicularly, the end of which has the mount 52 arm fastened to it, characterized by the pedestal (83) consisting of metal boxes (1 and 2) and L-profiles (3 and 4) welded to make a rectangle, but the boxes (1 and 2) have the boxes (5 [symbol] 6) pulled into them, the ends of which have welded castor (7 and 8) carriers to which the castors (9 and 10) are fastened with the elements (85 and 87) for fastening, while the castors (14 and 15) with the elements (84 [symbol] 86) for fastening are fastened to the castor (12 and 13) carriers, and the outer flanks of the boxes (1 and 2) have places (16 and 17) for mounting of the weight (18), in the upper side of the pedestal (83) each of the corners has the sleeves (19, 20, 21, 22) welded perpendicularly, which have the pipes (23, 24, 25, 26) pulled into them and fastened with the elements (29, 30, 31, 32) for fastening, and the tops of the pipes go into the sleeves (34, 35, 36, 37) of the frame (33) and are fastened with the elements (38, 39, 40, 41) for fastening going through just one of their sides, so that with the fastening (38) element there is also fastened the bar (42) pulled into the pipe (23), including the joint (44) which is followed by the bar (46), pipe (47), joint (48), pipe (50), bar (51) and the mount (52) arm, and the fixation (39) element also fixes the bar (43) pulled into the pipe (24) which includes the joint (45) and is followed by the pipe (53), joint (54), pipe (55), joint (57), as well as the pipe (60) which includes the keyboard (68 and 69) carriers and the mouse (80) pedestal.
